(19) United States
(12) Patent Application Publication
(10) Pub. No.: US 2020/0040629 A1
(43) Pub. Date: Feb. 6, 2020

(54) Flag stop door hinge

(71) Applicant: Benjamin W McLain, Chatham, IL (US)

(72) Inventor: Benjamin W McLain, Chatham, IL (US)

(21) Appl. No.: 16/055,073

(22) Filed: Aug. 4, 2018

(51) Int. Cl. E05D 11/10; E05F 5/02; E05D 11/06; E05D 3/02; E05D 5/14; E05D 5/10

(52) U.S. Cl. CPC E05D 11/1007; E05F 5/02; E05D 11/06; E05D 2005/102; E05D 5/14; E05D 5/10; E05D 3/02

(57) ABSTRACT

A hinge (FIG. 1) with an adjustable built-in door stop mechanism. The hinge contains two leaves and a hinge pin. The first leaf with three knuckles has various receptacles (4) on both the upper and lower knuckles (3) to ensure the door stop works with both right and left-handed doors. The hinge also contains a standard hinge pin (5) that includes a flag (6) immediately at the base of the pin head. The hinge is designed to stop when the pin flag (6) is inserted into one of the pin flag receptacles (4) limiting the swing range of motion of the hinge. The second leaf (2) will rotate until making contact with the pin flag (6) and the top knuckle (3), stopping the hinge from rotating any further. The appropriate pin flag receptacle (4) selected is based on the required swing of the hinge.

### BACKGROUND

The present invention relates generally to residential or commercial door hinges, more specifically, a hinge with a built-in door stop that limits the range of motion of the hinge to a predetermined position.

The standard residential or commercial door hinge allows for a door to swing freely on the door frame with full range of motion. This has long been an issue that caused problems with door handles or the door itself making contact with the materials immediately behind the door. Several patents have been developed to limit the range of motion of the door and prevent further damage to the materials immediately surrounding the door.

Initial patents utilized a wall, floor or baseboard mounted door stop that would be screwed into the wall, floor or baseboard to provide an immediate but secure stop that eliminated the damage to the materials behind the door. The issue with these items are that the door itself would become damaged or the mounted stops would break. These types of stops were also visually unappealing and took away from the décor of the home or commercial space.

Next came the hinge mounted attachments that eliminated the need for a wall mounted, floor or trim mounted stops. These were more visually appealing due to the fact that they were only attached to the hinges of the doors and they were less visible than a fixed wall, floor or baseboard mounted stop. The hinge mounted attachments also allowed for the flexibility to adjust the hinge range of motion by using screws to adjust the length of the stop. These types of hinges however still were prone to breaking or making holes in the door or the door trim in the area that comes into direct contact with the stopper.

Most recently there have been several patents that allow for built-in hinge door stops that eliminate the need for additional attachments and eliminate the damage to the door, trim and materials immediately surrounding the door. The issues have been that the built-in hinge door stops have been complicated and expensive to manufacture.

The Flag Stop Door Hinge is a simple, inexpensive built-in hinge door stop that is both visually appealing and eliminates the risk of damaging the door, trim, or materials immediately around the door. Because of the simplicity of the hinge design, the Flag Stop Door Hinge can be placed as all three door hinges to ensure stability and eliminate the need for additional hardware to stop the door from damaging any materials immediately around the door.

### SUMMARY OF INVENTION

The present invention represents a new hinge that provides the ability to limit the range of motion specific to the needs of each door. It utilizes a hinge with two leaves; leaf one (1) contains three knuckles (3) and leaf two contains two knuckles (3). Leaf one contains two flag receptacles (4) in both the upper and lower knuckles (3) that accept a pin flag (6) that is intended to stop the hinge at designated ranges to ensure the door does not hit the various materials located behind the door. Leaf one (1) contains flag receptacles (4) on both the upper and lower knuckles (3) to ensure it will work with both right and left-handed doors. The use of two flag receptacles (4) on each upper and lower knuckle (3) allows for the user to select the appropriate range of motion and ensures the hinge will stop at the desired range of motion for both right and left handed doors.

There is also a pin flag (6) that is included with the hinge that allows for the flag (6) to be inserted into the flag receptacle (4). The pin flag (6) is a one-piece item that when secured into the appropriate flag receptacle (4) will prohibit the hinge from opening as the second leaf (2) makes contact with the pin flag (6). This hard stop eliminates the need for additional door stopping hardware and eliminating the damage to the door, frame, wall, floor or baseboard.

It is important that when mounting the hinge to the door and door jam that leaf one (1), containing three knuckles, is mounted to the door jam and that the second leaf (2), containing two knuckles, is mounted to the door. This is due to the fact that the pin flag (6) should remain stationary and the door mounted second leaf (2) swings into contact with the pin flag (6). Keeping the pin flag (6) stationary ensures that the pin will not ride up and come out of the pin holes as commonly found with pin mounted door stops. It also ensures the pin flag (6) will come into contact with the second leaf (2). If the second leaf (2) was mounted to the door jam, the door trim around the door may interfere with the preselected range of motion and cause damage to the door trim.

### DESCRIPTIONS OF DRAWING

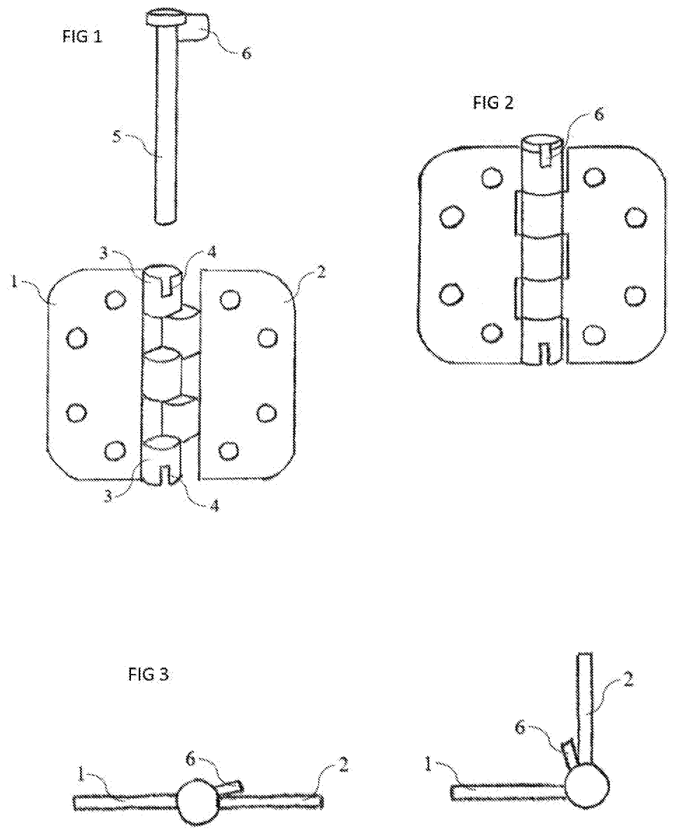

The Flag Stop Door Hinge is shown in three pieces (FIG. 1), fully assembled (FIG. 2) and as viewed from above (FIG. 3) with various stops utilized to limit range of motion to 90 degrees and 180 degrees of door range of motion.
1. Leaf one—contains three knuckles (3) and four holes for screw placement to allow the leaf to be attached to the door jam. This leaf must be attached to the door jam and not to the door to ensure sufficient range of motion and a stationary pin flag (6).
2. Leaf two—contains two knuckles and four holes for screw placement in the door. This leaf must be attached to the door itself and not to the door jam. This allows leaf two to rotate freely on the hinge pin (5).
3. Upper and lower knuckles—contains two pin flag receptacles (4) to allow the user to select the appropriate range of motion depending on the location of the door and the proximity to the wall. The upper and lower knuckles must be attached to the door jam as stated above.
4. Pin flag receptacles—are slots placed in the upper and lower knuckles (3) of each hinge. The receptacles are specifically located to allow for easy pin flag (6) placement that limits the range of motion of the hinge to the desired amount. The most common application is at 90 degree and 180 degree range of motion for the door. Custom hinges receptacles can be developed to allow for varying ranges of motion.
5. Hinge pin—utilized to join together leaf one (1) and leaf two (2) allowing a 360 degree range of motion when left free. The hinge pin contains a pin flag (6) that limits the range of motion of the hinge to a desired amount when placed in a flag receptacle (4).
6. Pin flag—attached to the hinge pin (5) at the base of the pin head. Utilized to stop the range of motion of the free swinging door when placed in a flag receptacle (4). The hinge pin (5) and pin flag are manufactured by the same materials and are one piece. The hinge pin (5) and pin flag do not come apart.

### CROSS-REFERENCE

Escobar, F. A, Salazar, S. A, U.S. Pat. No. 6,353,967—Ninety-degree door hinge, Sep. 2, 1999
Fitzgerald, M. W, U.S. Pat. No. 8,307,513—Door Hinge with Integrated Preset Stops, Nov. 13, 2012
Reid, E. A., U.S. Pat. No. 3,913,171—Door Hinge Pin Mounted Adjustable Door Stop, Oct. 21, 1975
Hooper, G. M., U.S. Pat. No. 2,803,850—Stop Hinge, Aug. 27, 1957
Glenn, G. G., U.S. Pat. No. 1,923,721—Hinge, Oct. 5, 1932
Smith, B. J., U.S. Pat. No. 8,327,505—Adjustable Door Stop System, Dec. 11, 2012
Heninger, B., U.S. Pat. No. 8,739,366—Hinge-Integrated Adjustable Door Stop, Jun. 3, 2014
Tolliver, P. M., U.S. Pat. No. 9,416,572—Adjustable Swing-Controlled Hinge, Aug. 16, 2016
Corso, S., Riela, S., Ilacqua, M., Cusati, G., US Patent 2012/0117760—Loose-Pin Hinge and Hinge Pin with Integrated Stop, May 17, 2012
Heninger, B. D., US Patent 2014/0173852—Hinge-Integrated Adjustable Door Stop, Jun. 26, 2014
Granberry, R. J., US Patent 2013/0114345—Hinge with Integral Stop, May 2, 2013

1. Leaf one (1) contains three knuckles (3), with the upper and lower knuckles to include pre-set pin flag receptacles (4) that are set to limit leaf range of motion to predetermined angles of hinge rotation, most commonly 90 and 180 degrees of rotation. Knuckles may include multiple receptacles and the location of receptacles may vary depending on the proximity of the door to the required range of motion of the hinge.

2. Upper and lower knuckles (3) of the first leaf both include flag receptacles (4) to allow for the same hinge to be utilized on right and left-handed doors.

3. Hinge pin (5) contains a pin flag (6) immediately below the pin head that will be inserted into the flag receptacle (4). The pin flag may be of varying shapes and sizes to adjust the swing of the door or to add style or safety features to the flag.

4. First leaf (1) should be attached to door frame, second leaf (2) should be attached to the door to allow the second leaf to swing freely, coming into contact with the pin flag (6), stopping the door.

5. Pin flag (6) inserts into appropriate upper knuckle flag receptacle (4) with the pin flag (6) limiting the range of motion for the second leaf (2) to swing.

6. The upper section of the second leaf (2) will make contact with the pin flag (6), stopping the motion of the hinge and door.

7. The Flag Stop Door Hinge is utilized on all three door hinges to evenly distribute the load throughout the door jam. This distribution prohibits damage to the door, jam, wall or hinge.
